(19) United States
(12) Patent Application Publication
(10) Pub. No.: US 2009/0068958 A1
(43) Pub. Date: Mar. 12, 2009

(54) FILTER FREQUENCY CHARACTERISTIC DETECTION DEVICE AND FILTER FREQUENCY CHARACTERISTIC TESTING DEVICE

(75) Inventor: Tetsuya Nakamura, Kawasaki-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/204,988

(22) Filed: Sep. 5, 2008

(30) Foreign Application Priority Data
Sep. 7, 2007 (JP) 2007-233228

(51) Int. Cl. H04B 17/00

(52) U.S. Cl. 455/67.16; 341/144; 375/226

(57) ABSTRACT

A filter frequency characteristic detection device includes a filter which receives a first signal and a second signal, a comparator which compares the first signal and the second signal which have passed through the filter, an offset adjusting circuit which gives an offset to each of the first signal and the second signal to be input to the comparator, a duty ratio detection circuit which detects, as a duty ratio, a change in an amplitude of the first signal and the second signal based on an output result from the comparator, and a frequency characteristic adjusting circuit which adjusts the frequency characteristic of the filter based on a detection result from the duty ratio detection circuit.

### CROSS-REFERENCE TO RELATED APPLICATIONS

This application is based upon and claims the benefit of priority from prior Japanese Patent Application No. 2007-233228, filed Sep. 7, 2007, the entire contents of which are incorporated herein by reference.

### BACKGROUND OF THE INVENTION

1. Field of the Invention

The present invention relates to a filter frequency characteristic detection device and filter frequency characteristic testing device which inputs signals having offsets to a comparator.

2. Description of the Related Art

In an IC filter circuit, the filter frequency characteristic varies due to, e.g., manufacturing variations of elements. This requires adjustment to raise the accuracy of the filter frequency characteristic.

For example, an automatic filter adjusting device of patent reference 1 coarsely adjusts a filter by using an amplitude detector so that the amplitude level of a filter output signal attains a predetermined value. When a filter characteristic frequency f0 almost matches the target frequency, fine adjustment is done in this state by comparing phases. Patent reference 1 requires a circuit for detecting the amplitudes of filter input and output signals and a phase comparator for comparing phases. This makes the circuit of the automatic filter adjusting device large and complex.

In an automatic adjusting IC filter circuit of patent reference 2, during a period when a reference carrier to be used in a channel different from the channel signal of its own is being input to a filter, the frequency characteristic is moved in the direction of the frequency axis by gradually changing a control signal for adjusting the filter frequency characteristic. The attenuation amount of the reference carrier output from the filter is monitored during the control signal supply period. When the attenuation amount has reached a predetermined value, the value of the control signal at that time is held. In patent reference 2, automatic adjustment of the IC filter circuit is complex, and the circuit size is large.

[Patent Reference 1] Jpn. Pat. Appln. KOKAI Publication No. 2005-197975

[Patent Reference 2] Jpn. Pat. Appln. KOKAI Publication No. 4-180406

### BRIEF SUMMARY OF THE INVENTION

A filter frequency characteristic detection device according to a first aspect of the present invention comprising: a filter which receives a first signal and a second signal; a comparator which compares the first signal and the second signal which have passed through the filter; an offset adjusting circuit which gives an offset to each of the first signal and the second signal to be input to the comparator; a duty ratio detection circuit which detects, as a duty ratio, a change in an amplitude of the first signal and the second signal based on an output result from the comparator; and a frequency characteristic adjusting circuit which adjusts the frequency characteristic of the filter based on a detection result from the duty ratio detection circuit.

A filter frequency characteristic detection device according to a second aspect of the present invention comprising: a filter which receives a first signal and a second signal; a D/A converter which gives an offset to each of the first signal and the second signal to be input to the filter; a comparator which compares the first signal and the second signal which have passed through the filter; a duty ratio detection circuit which detects, as a duty ratio, a change in an amplitude of the first signal and the second signal based on an output result from the comparator; and a frequency characteristic adjusting circuit which adjusts the frequency characteristic of the filter based on a detection result from the duty ratio detection circuit.

A filter frequency characteristic testing device according to a third aspect of the present invention comprising: a comparator which compares the first signal and the second signal which have passed through an external filter; an offset adjusting circuit which gives an offset to each of the first signal and the second signal to be input to the comparator; and a duty ratio detection circuit which detects, as a duty ratio, a change in an amplitude of the first signal and the second signal based on an output result from the comparator.

### BRIEF DESCRIPTION OF THE SEVERAL VIEWS OF THE DRAWING

FIG. 1 is a block diagram showing the schematic arrangement of a filter frequency characteristic detection device according to the first embodiment of the present invention;

FIGS. 2A and 2B are timing charts showing the duty ratios of the output signals of a comparator before and after offsets are given in detecting the filter frequency characteristic according to the first embodiment of the present invention;

FIG. 3 is a graph showing the relationship between the frequency and the amplitude of input signals to the comparator according to the first embodiment of the present invention;

FIG. 4 is a timing chart showing the frequency dependence of the duty ratio of the output signal of the comparator according to the first embodiment of the present invention;

FIG. 5 is a timing chart for explaining the relationship between the duty ratio and the amplitude according to the first embodiment of the present invention;

FIGS. 6A to 6C are graphs for explaining the relationship between the duty ratio and the amplitude according to the first embodiment of the present invention;

FIG. 7 is a block diagram showing the schematic arrangement of a filter frequency characteristic detection device according to the second embodiment of the present invention;

FIG. 8 is a block diagram showing the schematic arrangement of a filter frequency characteristic detection device according to the third embodiment of the present invention;

FIG. 9 is a block diagram showing the schematic arrangement of a filter frequency characteristic detection device according to the fourth embodiment of the present invention;

FIG. 10 is a block diagram showing a schematic arrangement of a filter frequency characteristic testing device according to the fifth embodiment of the present invention; and

FIG. 11 is a block diagram showing another schematic arrangement of the filter frequency characteristic testing device according to the fifth embodiment of the present invention.

### DETAILED DESCRIPTION OF THE INVENTION

The embodiments of the present invention will now be described with reference to the accompanying drawing. In the following description, the same reference numerals denote the same parts throughout the drawing.

### [1] First Embodiment

In the first embodiment, to detect the frequency characteristic of, e.g., an analog IC filter, offsets are given to the difference signals at the input portion of a filter. A comparator compares the difference signals having the offsets so that a change in the signal amplitude is detected as a duty ratio.

### [1-1] Arrangement of Filter Frequency Characteristic Detection Device

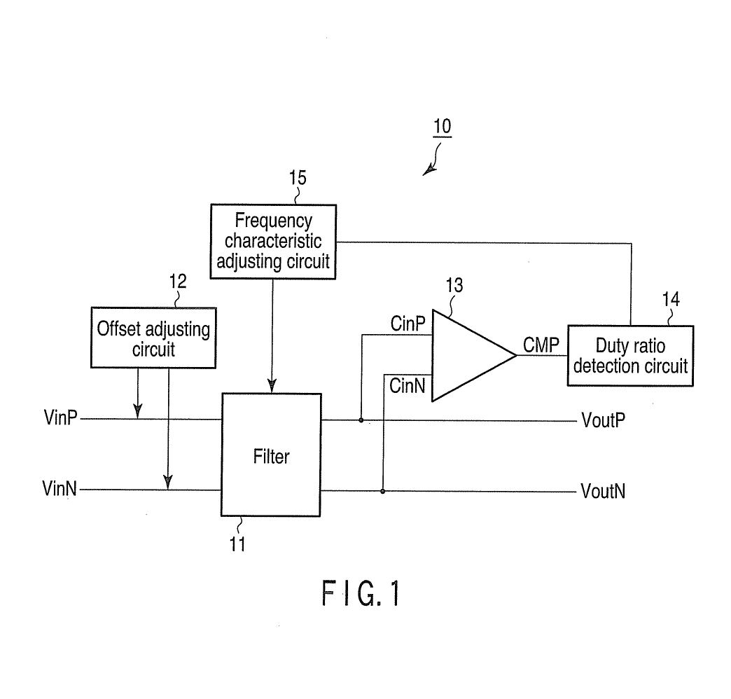

FIG. 1 is a block diagram showing the arrangement of a filter frequency characteristic detection device according to the first embodiment of the present invention. The schematic arrangement of the filter frequency characteristic detection device according to the first embodiment will be described below.

As shown in FIG. 1, a filter frequency characteristic detection device 10 includes a filter 11, offset adjusting circuit 12, comparator 13, duty ratio detection circuit 14, and frequency characteristic adjusting circuit 15.

The filter 11 functions as, e.g., a band-pass filter (BPF), high-pass filter (HPF), or low-pass filter (LPF). The filter 11 receives difference signals VinP and VinN. The difference signals VinP and VinN are inverted signals which have the same frequency and amplitude and a phase difference of 180° (½ period).

The offset adjusting circuit 12 gives, by a variable voltage or the like, offsets to the difference signals VinP and VinN to be input to the filter 11. More specifically, the offset adjusting circuit 12 gives an offset −H to the difference signal VinP and an offset +H to the difference signal VinN. That is, the difference signals VinP and VinN are given offsets so that their waveform charts shift in the opposite directions.

The comparator 13 receives signals CinP and CinN which are given the offsets and passed through the filter 11. The comparator 13 compares the signals CinP and CinN and outputs a signal CMP of the comparison result.

The duty ratio detection circuit 14 detects the duty ratio of the signal CMP output from the comparator 13. The duty ratio indicates the digitized amplitude change of the signals CinP and CinN and is represented by a ratio (W/T) of a signal ON time W to one period T.

The frequency characteristic adjusting circuit 15 supplies a predetermined control signal to the filter 11 based on the result from the duty ratio detection circuit 14, thereby adjusting the frequency characteristic of the filter 11.

In this embodiment, the offset adjusting circuit 12 need not always be arranged separately from the filter 11. Instead, the filter 11 itself may have the function of giving an offset.

### [1-2] Method of Detecting and Adjusting Filter Frequency Characteristic

The outline of detection and adjustment of the filter frequency characteristic using the filter frequency characteristic detection device 10 according to this embodiment will be described with reference to FIG. 1.

First, the difference signals VinP and VinN that are inverted signals are input to the filter 11. The offset adjusting circuit 12 gives offsets to the difference signals VinP and VinN to be input to the filter 11. The difference signals VinP and VinN having the offsets are input to the comparator 13 via the filter 11. The comparator 13 compares the input signals CinP and CinN having the offsets and outputs the comparison result. The signal CMP output from the comparator 13 is input to the duty ratio detection circuit 14. The duty ratio detection circuit 14 detects a digital signal which represents a change in the amplitude of the signals CinP and CinN as a change in the duty ratio. The change in the signal amplitude is calculated from the duty ratio. Based on the detection result from the duty ratio detection circuit 14, the frequency characteristic adjusting circuit 15 performs adjustment to raise the accuracy of the frequency characteristic of the filter 11 so that the amplitude level reaches a predetermined value.

### [1-3] Duty Ratio

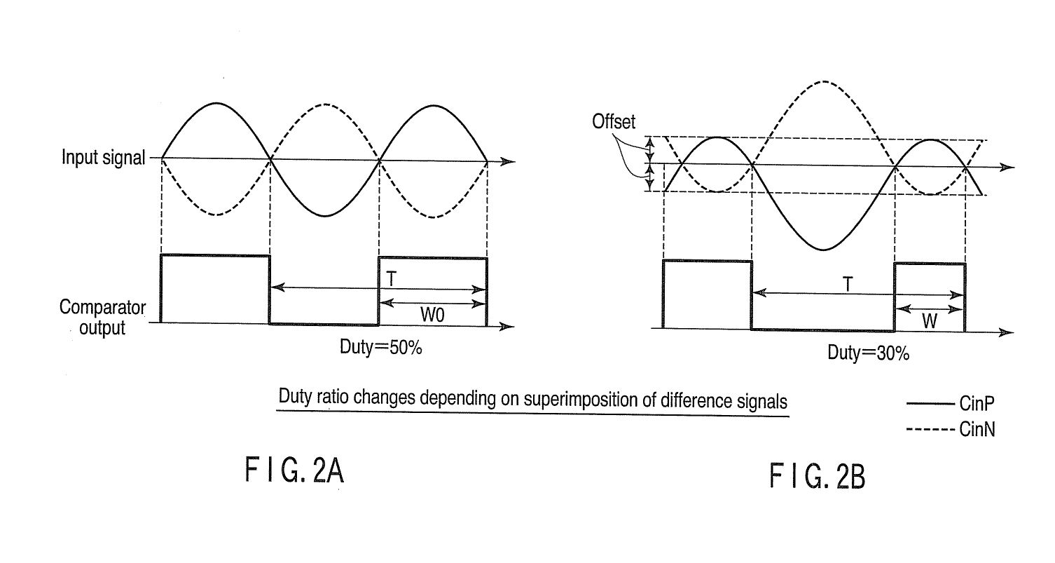

FIGS. 2A and 2B show the duty ratios of the output signals of the comparator before and after the offsets are given in detecting the filter frequency characteristic according to the first embodiment of the present invention. The change in the duty ratio caused by giving the offsets will be explained below. Note that the duty ratio is represented here by the ratio of the signal ON time W to one period T.

As shown in FIG. 2A, when the difference signals VinP and VinN without offsets are input to the comparator 13, a duty ratio W₀/T of the output signal of the comparator 13 is 50%.

As shown in FIG. 2B, when the difference signals VinP and VinN given the offsets are input to the comparator 13, the signals CinP and CinN input to the comparator 13 have offsets so that they shift in the opposite directions from each other. For this reason, a duty ratio W/T of the output signal of the comparator 13 is 30%. As is apparent, when the offsets are given, the waveforms of the signals CinP and CinN shift, and the superimposition of their waveforms changes so that the duty ratio changes.

### [1-4] Relationship Between Duty Ratio and Frequency

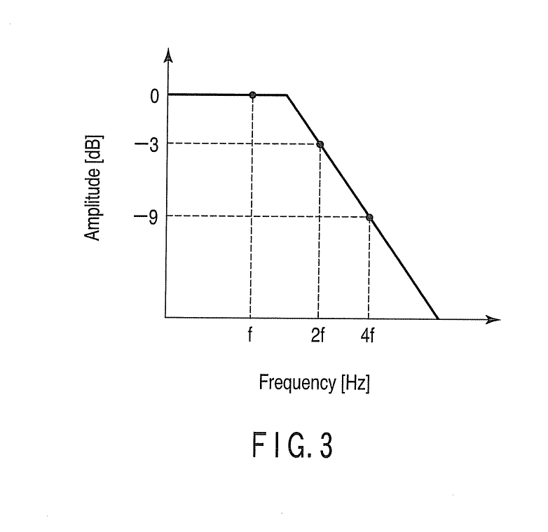

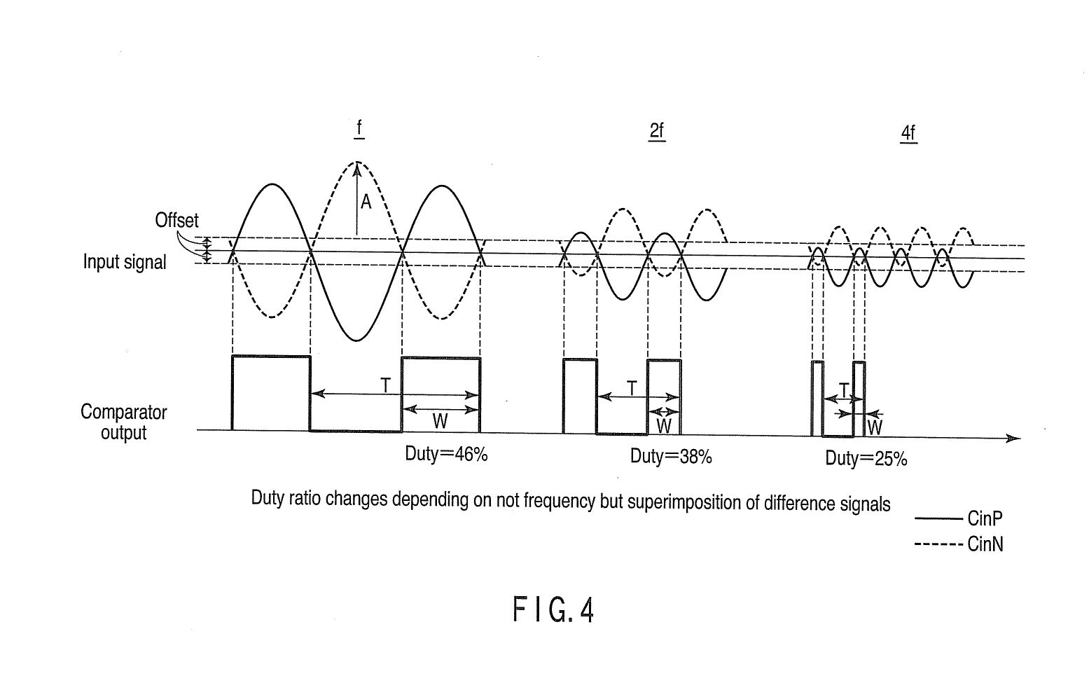

FIG. 3 is a graph showing the relationship between the frequency and the amplitude of the input signals to the comparator according to the first embodiment of the present invention. FIG. 4 shows the frequency dependence of the duty ratio of the output signal of the comparator according to the first embodiment of the present invention. The relationship between the duty ratio and the frequency will be described below. Note that the duty ratio is represented here by the ratio of the signal ON time W to one period T.

As shown in FIG. 3, when the frequency of the signals CinP and CinN input to the comparator changes to f, 2f, and 4f, the amplitude changes to 0, −3, and −9. On the other hand, the duty ratio W/T changes depending on not the change of the frequencies f, 2f, and 4f but always the change of the superimposition of the signals CinP and CinN. More specifically, when the same offsets are given for all the frequencies f, 2f, and 4f, the duty ratios W/T corresponding to the frequencies f, 2f, and 4f are 46%, 38%, and 25%, respectively.

### [1-5] Relationship Between Duty Ratio and Amplitude

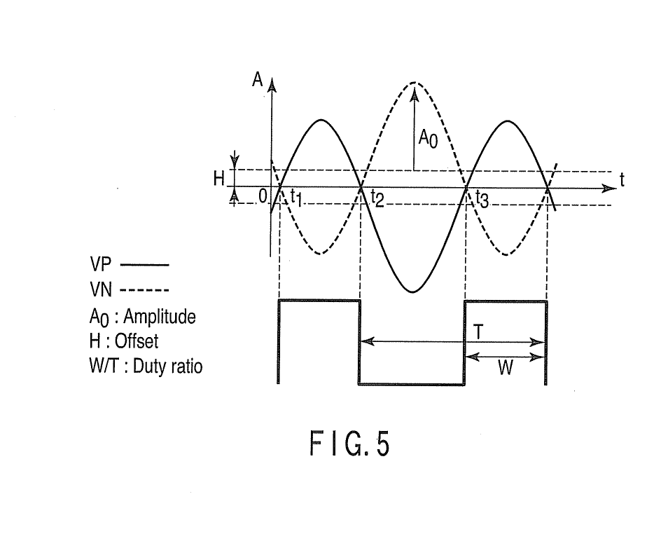

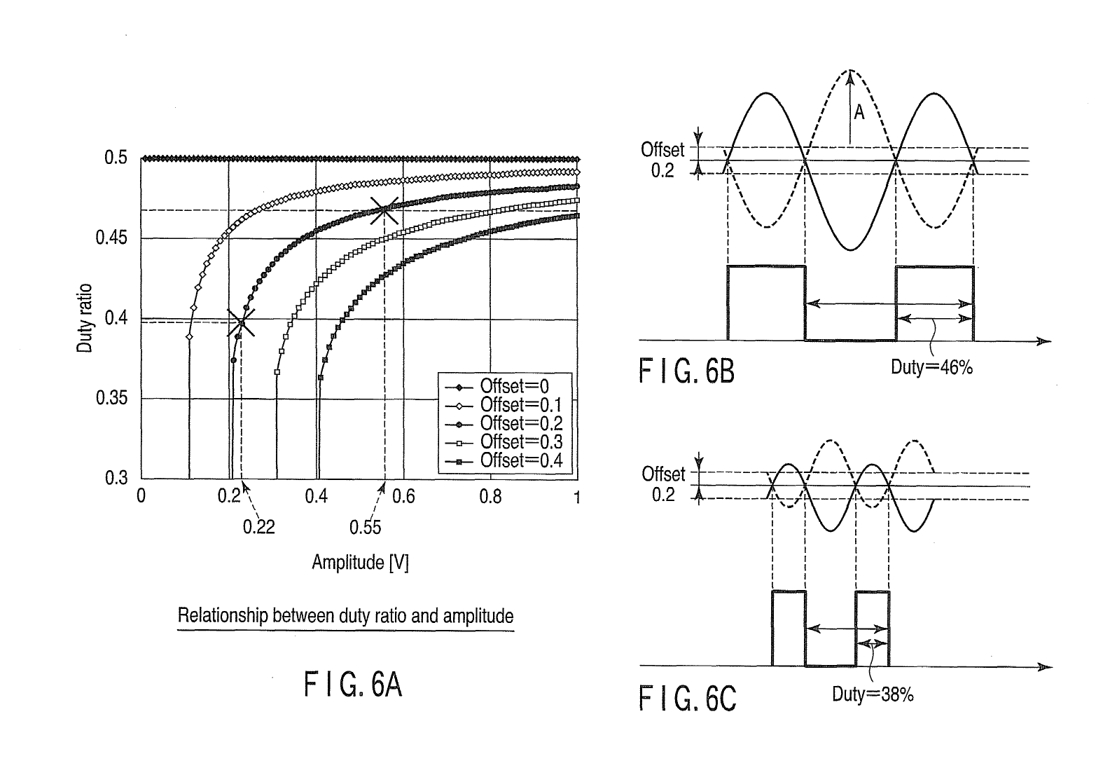

FIGS. 5 and 6A to 6C are timing charts for explaining the relationship between the duty ratio and the amplitude according to the first embodiment of the present invention. The relationship between the duty ratio and the amplitude of the difference signals given offsets will be explained below.

As shown in FIG. 5, let VP and VN be the difference signals, A₀ be the amplitude, H be the offset, and W/T be the duty ratio. In this case, when the duty ratio W/T is known, a signal amplitude A can be calculated in the following way.

VP and VN are given by

VP=A₀ sin(ωt) (1)

VN=−A₀ sin(ωt) (2)

When the offset H is given to VP and VN, we obtain

VP=A₀ sin(ωt)−H (3)

VN=−(A₀ sin(ωt)−H) (4)

The intersection of VP and VN is obtained. The transpositions of the values of VP and VN are represented by binary values “0” and “1”, and the duty ratio of “0” and “1” is obtained.

The intersection of VP and VN is always the median (A=0). For a point ωt₁,

0=A₀ sin(ωt₁)−H

∴ sin(ωt₁)=H/A

For points ωt₂ and ωt₂,

0=A₀ sin(ωt₂)−H=A₀ sin(π−ωt₁)−H

0=A₀ sin(ωt₃)−H=A₀ sin(2π+ωt₁)−H

Then, we obtain

ωt₁=arcsin(H/A₀) (5)

ωt₂=π−arcsin(H/A₀) (6)

ωt₃=2π+arcsin(H/A₀) (7)

When duty ratios are obtained using equations (5) and (6), we obtain

duty ratio=(ωt₂−ωt₁)/2π

duty ratio={π−2 arcsin(H/A₀)}/2π (8)

As is apparent from equation (8), when the duty ratio and offset H are known, the amplitude A₀ can be derived. It also indicates that the duty ratio does not depend on the frequency ω.

FIG. 6A shows the relationship between the duty ratio and the amplitude. In FIG. 6A, the abscissa represents the amplitude, and the ordinate represents the duty ratio. The offset is changed to 0, 0.1, 0.2, 0.3, and 0.4.

As described above, to detect the filter frequency characteristic, first, the comparator 13 detects the superimposition of difference signals. The duty ratio is detected based on the signal CMP output from the comparator 13. The signal amplitude can be obtained from the relationship shown in FIG. 5 on the basis of the duty ratio and the offset given to the difference signals.

For example, when the duty ratio is 46%, and the offset given to the difference signals is 0.2, as shown in FIG. 6B, the amplitude is 0.55, as is apparent from the relationship in FIG. 6A. When the duty ratio is 38%, and the offset given to the difference signals is 0.2, as shown in FIG. 6C, the amplitude is 0.22, as is apparent from the relationship in FIG. 6A.

As described above, in this embodiment, the relationship between the amplitude and the duty ratio is known, as shown in FIG. 6A. For this reason, it is possible to calculate the signal amplitude by obtaining the duty ratio from the signal CMP output from the comparator 13.

### [1-6] Effects

According to the first embodiment, the offset adjusting circuit 12 gives offsets to the difference signals VinP and VinN to be input to the filter 11. The signals are input to the comparator 13. The change in the signal amplitude is measured as the change in the duty ratio of the output result (1/0 digital value) of the comparator 13. Based on the duty ratio, the frequency characteristic (attenuation amount) of the filter 11 is calculated, and the filter is adjusted to obtain a desired value. In this embodiment, the signal amplitude change amount can be measured not as an analog signal but as a 1/0 digital value. It is therefore possible to easily detect the filter frequency characteristic. Additionally, since the device includes only an offset adjusting means and a simple comparator, no complex circuit arrangement is necessary.

### [2] Second Embodiment

The offset adjusting circuit 12 can be arranged before or after the filter 11 in accordance with, e.g., the filter performance or system arrangement. In the first embodiment, the offset adjusting circuit 12 is arranged at the input portion of the filter 11. In the second embodiment, however, an offset adjusting circuit 12 is arranged at the output portion of a filter 11. A description of the same points as in the first embodiments will not be repeated.

### [2-1] Arrangement of Filter Frequency Characteristic Detection Device

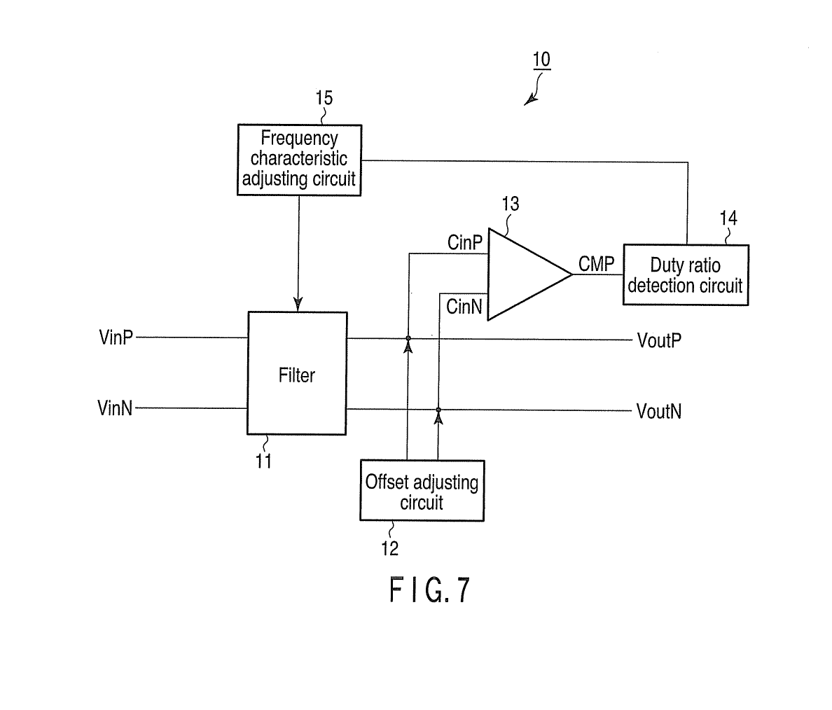

FIG. 7 is a block diagram showing the arrangement of a filter frequency characteristic detection device according to the second embodiment of the present invention. The schematic arrangement of the filter frequency characteristic detection device according to the second embodiment will be described below.

As shown in FIG. 7, the filter frequency characteristic detection device of the second embodiment is different from the first embodiment in that the offset adjusting circuit 12 is connected to the output portion of the filter 11. Hence, in this embodiment, the offset adjusting circuit 12 gives offsets to difference signals VinP and VinN output from the filter 11.

In this embodiment, the offset adjusting circuit 12 need not always be arranged separately from the filter 11. Instead, the filter 11 itself or a comparator 13 itself may have the function of giving an offset.

### [2-2] Effects

According to the second embodiment, it is possible to obtain the same effects as in the first embodiment. Additionally, in the second embodiment, the offsets are given to the difference signals VinP and VinN that have passed through the filter 11. For this reason, the device is also applicable to a filter such as a band-pass filter or high-pass filter that passes no DC voltage, unlike the arrangement which gives offsets to the difference signals VinP and VinN to be input to the filter 11.

### [3] Third Embodiment

In the third embodiment, a D/A converter (DAC: digital-to-analog converter) at the preceding stage of a filter gives offsets to difference signals. A description of the same points as in the first embodiments will not be repeated.

### [3-1] Arrangement of Filter Frequency Characteristic Detection Device

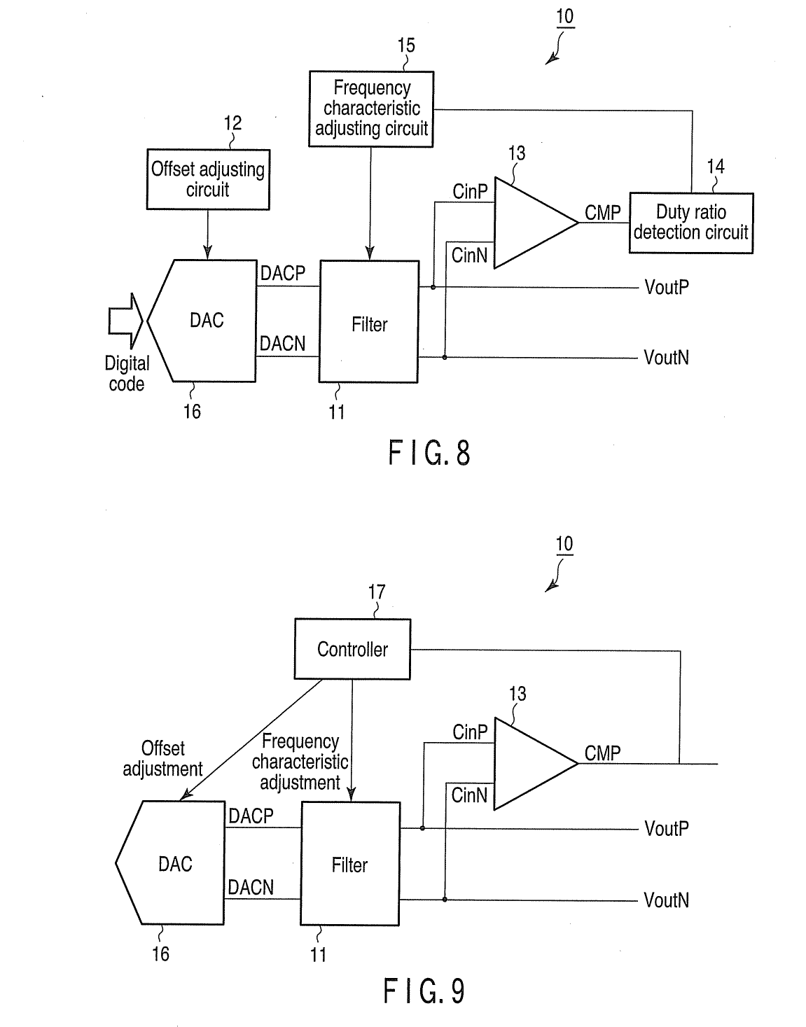

FIG. 8 is a block diagram showing the arrangement of a filter frequency characteristic detection device according to the third embodiment of the present invention. The schematic arrangement of the filter frequency characteristic detection device according to the third embodiment will be described below.

As shown in FIG. 8, the filter frequency characteristic detection device of the third embodiment is different from the first embodiment in that a D/A converter 16 is added at the preceding stage of a filter 11 and used as an offset adjusting circuit.

The D/A converter 16 converts a digital input signal into an analog signal almost proportional to the digital signal. The D/A converter 16 receives a digital code and outputs signals DACP and DACN which are difference signals having offsets.

In this embodiment, since the D/A converter 16 itself has an offset adjusting function, an offset adjusting circuit 12 may be omitted.

### [3-2] Effects

According to the third embodiment, it is possible to obtain the same effects as in the first embodiment. Additionally, in the third embodiment, since the offsets are given to the signals output from the D/A converter 16, all input and output signals can be measured as 1/0 digital values. This obviates analog signal processing and further facilitates detection and adjustment of the filter frequency characteristic.

### [4] Fourth Embodiment

In the fourth embodiment, the offset adjusting circuit 12, duty ratio detection circuit 14, and frequency characteristic adjusting circuit 15 of the third embodiment are integrated into one controller. A description of the same points as in the third embodiments will not be repeated.

### [4-1] Arrangement of Filter Frequency Characteristic Detection Device

FIG. 9 is a block diagram showing the arrangement of a filter frequency characteristic detection device according to the fourth embodiment of the present invention. The schematic arrangement of the filter frequency characteristic detection device according to the fourth embodiment will be described below.

As shown in FIG. 9, the filter frequency characteristic detection device of the fourth embodiment is different from the third embodiment in that a controller 17 having the functions of the offset adjusting circuit 12, duty ratio detection circuit 14, and frequency characteristic adjusting circuit 15 of the third embodiment is provided.

The controller 17 detects the duty ratio of a signal CMP output from a comparator 13. The controller 17 supplies a predetermined control signal to a filter 11 based on the result from the duty ratio detection circuit 14, thereby adjusting the frequency characteristic of the filter 11. The controller 17 generates a code which causes a D/A converter 16 to output difference signals DACP and DACN as difference signals having offsets.

The controller 17 may have only the functions of the offset adjusting circuit 12 and frequency characteristic adjusting circuit 15. Independently of the controller 17, the duty ratio detection circuit 14 may be provided at the output portion of the comparator 13.

### [4-2] Effects

According to the fourth embodiment, it is possible to obtain the same effects as in the third embodiment. Additionally, in the fourth embodiment, the offset adjusting circuit 12, duty ratio detection circuit 14, and frequency characteristic adjusting circuit 15 of the third embodiment are integrated into one controller 17. This reduces the size of a filter frequency characteristic detection device 10, facilitates design, and simplify the circuit arrangement.

### [5] Fifth Embodiment

The fifth embodiment is an example of a device for testing a filter frequency characteristic. The device gives offsets to difference signals and detects a duty ratio, as in the above-described first to fourth embodiments.

### [5-1] Arrangement of Filter Frequency Characteristic Testing Device

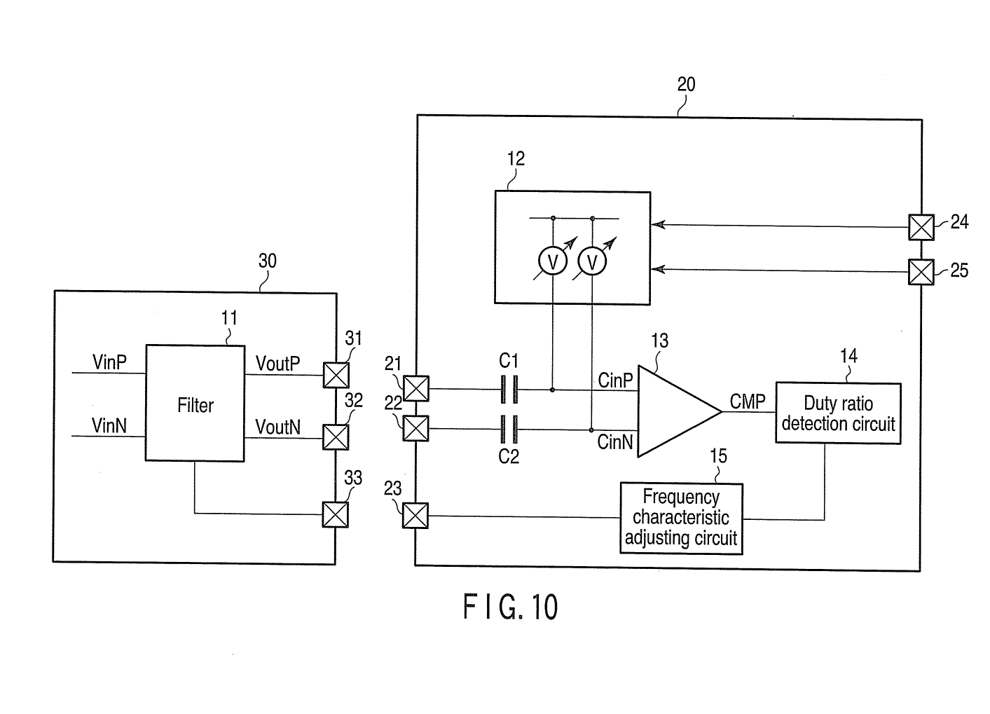

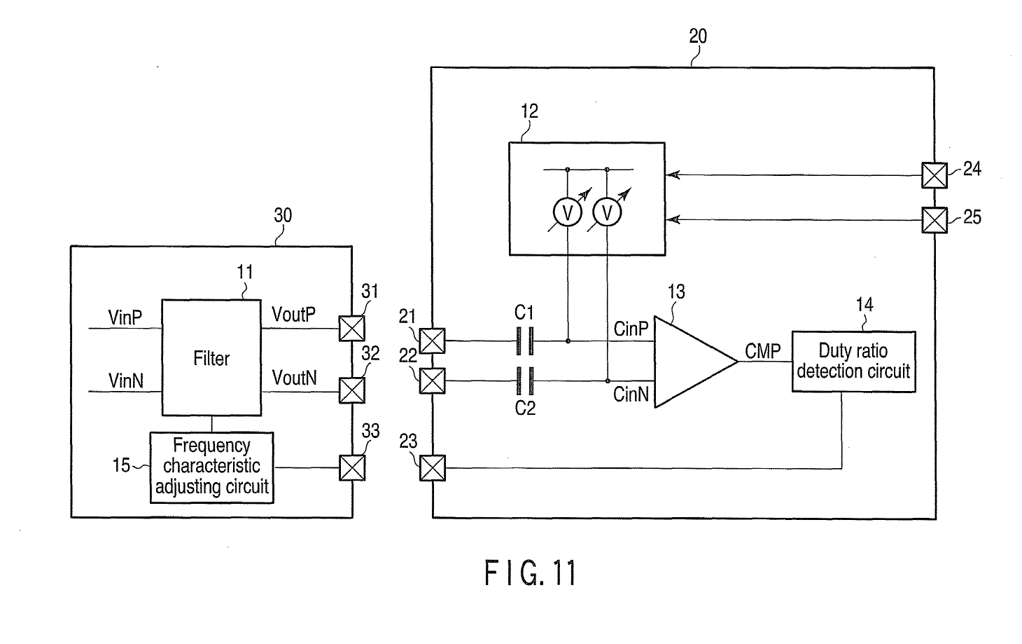

FIGS. 10 and 11 are block diagrams showing schematic arrangements of a filter frequency characteristic testing device according to the fifth embodiment of the present invention. The schematic arrangements of the filter frequency characteristic testing device according to the fifth embodiment will be described below.

As shown in FIGS. 10 and 11, a filter frequency characteristic testing device 20 is separated from a chip 30 having a filter 11 and provided outside the chip 30.

The filter frequency characteristic testing device 20 shown in FIG. 10 includes an offset adjusting circuit 12, comparator 13, duty ratio detection circuit 14, frequency characteristic adjusting circuit 15, and capacitors C1 and C2. The filter frequency characteristic testing device 20 shown in FIG. 11 includes the offset adjusting circuit 12, comparator 13, duty ratio detection circuit 14, and capacitors C1 and C2. In FIG. 10, the filter frequency characteristic testing device 20 includes the frequency characteristic adjusting circuit 15. In FIG. 11, however, the chip 30 outside the filter frequency characteristic testing device 20 includes the frequency characteristic adjusting circuit 15.

As shown in FIGS. 10 and 11, terminals 21, 22, 23, 24, and 25 are arranged at the periphery of the filter frequency characteristic testing device 20. Terminals 31, 32, and 33 are arranged at the periphery of the chip 30. The terminals 21 and 22 are connected to the terminals 31 and 32 to input difference signals VoutP and VoutN from the filter 11 to the comparator 13. The terminal 23 is connected to the terminal 33 to enable the frequency characteristic adjusting circuit 15 to adjust the frequency characteristic of the filter 11 based on the detection result from the duty ratio detection circuit 14. The terminals 24 and 25 are used to input a control signal to control the offset voltage of the offset adjusting circuit 12.

### [5-2] Filter Frequency Characteristic Testing Method

A filter frequency characteristic testing method using the filter frequency characteristic testing device 20 of this embodiment will be described with reference to FIGS. 10 and 11.

The filter 11 in the chip 30 receives difference signals VinP and VinN and outputs the difference signals VoutP and VoutN. To test the frequency characteristic of the filter 11, the filter frequency characteristic testing device 20 is used. More specifically, the terminals 21 and 22 of the filter frequency characteristic testing device 20 are connected to the terminals 31 and 32 of the chip 30 to input the signals VoutP and VoutN output from the filter 11 to the comparator 13 via the capacitors C1 and C2. The offset adjusting circuit 12 gives offsets to input signals CinP and CinN to the comparator 13. The comparator 13 compares the input signals CinP and CinN having the offsets and outputs the comparison result. The signal CMP output from the comparator 13 is input to the duty ratio detection circuit 14. The duty ratio detection circuit 14 detects a digital signal which represents a change in the amplitude of the signals CinP and CinN as a change in the duty ratio. A change in the signal amplitude is calculated from the duty ratio. The frequency characteristic of the filter 11 is tested in this way.

To adjust the frequency characteristic based on the test result of the filter 11, the terminal 23 of the filter frequency characteristic testing device 20 is connected to the terminal 33 of the chip 30. Based on the detection result from the duty ratio detection circuit 14, the frequency characteristic adjusting circuit 15 performs adjustment to raise the accuracy of the frequency characteristic of the filter 11 so that the amplitude level attains a predetermined value.

### [5-3] Effects

According to the fifth embodiment, the offset adjusting circuit 12 gives offsets to the difference signals VinP and VinN to be input to the filter 11, and the signals are input to the comparator 13, as in the first embodiment. The change in the signal amplitude is measured as the change in the duty ratio of the output result (1/0 digital value) of the comparator 13. Hence, in this embodiment, the signal amplitude change amount can be measured not as an analog signal but as a 1/0 digital value. It is therefore possible to easily test the filter frequency characteristic. Additionally, since the device includes only an offset adjusting means and a simple comparator, no complex circuit arrangement is necessary.

Use of the filter frequency characteristic testing device 20 facilitates test of the frequency characteristic of the existing filter 11. In addition, when the power supply voltage of the filter frequency characteristic testing device 20 is set to be higher than that of the chip 30 having the filter 11, the adjustment range widens, and measurement can become easier.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A filter frequency characteristic detection device comprising:
a filter which receives a first signal and a second signal;
a comparator which compares the first signal and the second signal which have passed through the filter;
an offset adjusting circuit which gives an offset to each of the first signal and the second signal to be input to the comparator;
a duty ratio detection circuit which detects, as a duty ratio, a change in an amplitude of the first signal and the second signal based on an output result from the comparator; and
a frequency characteristic adjusting circuit which adjusts the frequency characteristic of the filter based on a detection result from the duty ratio detection circuit.

2. The device according to claim 1, wherein the offset adjusting circuit gives the offset to each of the first signal and the second signal to be input to the filter.

3. The device according to claim 2, wherein the filter includes the offset adjusting circuit.

4. The device according to claim 1, wherein the first signal and the second signal are difference signals.

5. The device according to claim 1, wherein the detection result from the duty ratio detection circuit is a digital value.

6. The device according to claim 1, wherein the offset adjusting circuit gives the offset to each of the first signal and the second signal output from the filter.

7. The device according to claim 6, wherein one of the filter and the comparator includes the offset adjusting circuit.

8. The device according to claim 7, wherein the filter passes no DC voltage.

9. The device according to claim 8, wherein the filter is one of a band-pass filter, a high-pass filter and a low-pass filter.

10. A filter frequency characteristic detection device comprising:
a filter which receives a first signal and a second signal;
a D/A converter which gives an offset to each of the first signal and the second signal to be input to the filter;
a comparator which compares the first signal and the second signal which have passed through the filter;
a duty ratio detection circuit which detects, as a duty ratio, a change in an amplitude of the first signal and the second signal based on an output result from the comparator; and
a frequency characteristic adjusting circuit which adjusts the frequency characteristic of the filter based on a detection result from the duty ratio detection circuit.

11. The device according to claim 10, wherein the first signal and the second signal are difference signals.

12. The device according to claim 10, further comprising an offset adjusting circuit which adjusts the offset to be given to the first signal and the second signal.

13. The device according to claim 10, wherein the duty ratio detection circuit and the frequency characteristic adjusting circuit are included in a controller.

14. A filter frequency characteristic testing device comprising:
a comparator which compares the first signal and the second signal which have passed through an external filter;
an offset adjusting circuit which gives an offset to each of the first signal and the second signal to be input to the comparator; and
a duty ratio detection circuit which detects, as a duty ratio, a change in an amplitude of the first signal and the second signal based on an output result from the comparator.

15. The device according to claim 14, further comprising a frequency characteristic adjusting circuit which adjusts a frequency characteristic of the external filter based on a detection result from the duty ratio detection circuit.

16. The device according to claim 14, further comprising a terminal which outputs a signal to adjust the frequency characteristic of the external filter based on the detection result from the duty ratio detection circuit.

17. The device according to claim 14, further comprising:
a first terminal and a second terminal which input, to the comparator, the first signal and the second signal which have passed through the external filter; and
a first capacitor and a second capacitor provided between the comparator and the first terminal and the second terminal, respectively.

18. The device according to claim 14, further comprising a first terminal and a second terminal which supply a control signal to control an offset voltage of the offset adjusting circuit.

19. The device according to claim 14, wherein the first signal and the second signal are difference signals.

20. The device according to claim 14, wherein the detection result from the duty ratio detection circuit is a digital value.
